(19) United States
(12) Patent Application Publication
(10) Pub. No.: US 2008/0029376 A1
(43) Pub. Date: Feb. 7, 2008

(54) Electric control switch with push-button

(75) Inventor: Olivier Ngoagouni, Valence (FR)

Correspondence Address: STEPTOE & JOHNSON LLP, 1330 CONNECTICUT AVENUE, N.W., WASHINGTON, DC, 20036, US

(73) Assignee: Crouzet Automatismes, Valence (FR)

(21) Appl. No.: 11/819,896

(22) Filed: Jun. 29, 2007

(30) Foreign Application Priority Data
Aug. 1, 2006 (FR) 06 07036

(51) Int. Cl. H01H 3/12; H01H 13/50

(52) U.S. Cl. 200/345

(57) ABSTRACT

An electric control switch with a push-button comprises an electric contact having a first and a second electric state and an operating push-button having a first operating means designed to move due to the action of the external operating force. The operating push-button comprises a second operating means moving due to the action of an internal operating force to move the electric contact or contacts from the first electric state to the second electric state. The control switch comprises disconnection means between the first operating means and the electric contact or contacts. Said means comprise means for moving the electric contact or contacts from the first electric state to the second electric state and vice-versa at a speed the maximum value whereof is predetermined.

### BACKGROUND OF THE INVENTION

The invention relates to an electric control switch with a push-button comprising a case housing at least one electric contact having at least a first and a second electric state and an operating push-button. Said push-button comprises a first operating means designed to move by the action of the external operating force, and a second operating means moving by the action of an internal operating force to move said at least one electric contact from a first electric state to a second electric state. The electric control switch with a push-button comprises disconnection means between the first operating means and said at least one electric contact.

### STATE OF THE PRIOR ART

The use of an electric switch having an operating means with straight movement, such as push-buttons, is extremely widespread.

As represented in FIGS. 1 to 6, existing solutions generally comprise an operating push-button 4 able to move in translation between a position performing command of an electric contact and a rest position. The operating push-button 4 is generally kept in its rest position by the action of flexible means.

The operating push-button 4 comprises two ends, a first end whereon an operating force is exerted and a second end designed to command closing or opening of the electric contact either directly or indirectly. The second end of the operating push-button 4 can comprise connection means able to operate directly in closing or opening of the electric contact. In addition, the second end can command opening or closing of the electric contact in indirect manner. The second end of the operating push-button 4 then actuates command of an electric cell 10 such as a microswitch or a changeover switch. The electric contact 3 is then located inside said electric cell.

Applying the operating force FC to the operating push-button 4 tends to make the latter move from its rest position to its operating position. The force that the flexible means apply on the operating push-button 4 tends to oppose movement of said push-button from its rest position to its operating position. The flexible means, preferably comprising a helical spring, are compressed when the push-button is in its operating position. As soon as the action on the operating push-button 4 is annulled, the operating force FC is also annulled and the flexible means tend to bias said push-button to return to its rest position.

Solutions have been developed to prevent the action of the operating push-button 4 from damaging the electric contact when movement of the latter takes place from its rest position to its operating position. These solutions tend to limit the effects of the operating force FC when the latter is too strong. When an excessive operating force is applied to the operating push-button 4, excess energy is in fact absorbed at the level of the electric contact zone 3, which may result in said zone being damaged.

These solutions moreover also tend to adapt the travel of the operating push-button 4 to that of the electric cell. The travel of the operating push-button 4 is in fact generally greater than that of the electric cell.

A solution described in the U.S. Pat. No. 6,765,164 tends to remedy this problem. The electric control switch with push-button as presented in FIGS. 1 to 3 then comprises two springs fitted in series. According to one embodiment, the two springs have different stiffnesses. Operation of this type of control switch is as follows. When a non-excessive operating force FC is applied to the operating push-button 4, as represented in FIG. 2, only the first spring having the lower stiffness is compressed due to the action of the operating force FC. The second spring having the greater stiffness is not compressed. Operation of the electric control switch with push-button is then identical to the embodiment described above. When an excessive operating force is applied to the operating push-button 4, said push-button moves from its rest position to its operating position compressing the first spring in the same way as when a non-excessive operating force is applied, and the electric contact then changes state. As represented in FIG. 3, on account of the fact that the operating force is excessive, the second spring is in turn compressed and absorbs the excess energy in place of the electric contact.

The arrangement of the two springs and the kinematics of the mechanism can be slightly different as represented in FIGS. 4 to 6. The operating push-button 4 comprises two pistons 5, 6 able to move with respect to one another in the operating direction. Each movable piston is subjected to the forces of the independent flexible means. The operating principle remains close to that described above. Movement of the first piston 5 due to the action of an operating force FC compresses the return spring. The second piston 6 also moves in the direction of the electric contact, driven by the movement of the first piston via the second spring. According to this embodiment the electric contact is integrated in an electric cell 10.

As represented in FIG. 5, as soon as the second piston 6 is in contact with the cell 10, it commands change of the electric state of the electric contact 3.

If the first piston 5 continues to move under the effect of the operating force FC, the second spring then begins to compress. The second piston 6 remains fixed against the stop formed by the electric cell 10 whereas the first piston 5 can continue its travel. The forces exerted on said cell are limited to those of the compression force of the second spring on the second piston 6. These compression forces are generally weaker than those which could be exerted directly by the operating force FC. According to this embodiment, the stiffness of the second compression spring is in fact chosen such as to limit the compression forces on the electric cell 10.

In a general manner, these mechanical solutions do however present the drawback of having a permanent kinematic link between the push-button and the electric contact. Beyond a certain speed of movement of the operating push-button 4 due to the action of the operating force, the efficiency of the means implemented in existing solutions can be totally jeopardized. The springs can in particular harden and no longer compress as quickly as the movement of the actuator. The electric contact in this case receives too much energy which can result in more or less important damage to its parts. The mechanical endurance of the push-button can then be degraded.

Other solutions enable the kinematic chain to be partially broken. The document U.S. Pat. No. 3,100,824 describes an operating mechanism where an autonomy of operation of the operating means is observed, in particular the operating push-button and the operating means part of the electric contact or contacts. However this disconnection in operation of the operating push-button and the operating means part is only verified when actuation thereof is performed. When the operating push-button translates and compresses a first spring due to the action of an operating force, release of a lever arm and actuation of the electric contact of the electric cell are observed. In this first step of operation, switching from a first electric state to a second electric state then takes place due to the action of a second spring and is independent of the operating force. In other words, beyond a certain speed of movement of the operating push-button, the speed of switching of the electric contact is independent of the speed of movement of said push-button. However, when switching takes place from the second electric state to the first electric state (reverse operation), the speed of change of electric state of the electric contact is directly dependent on the speed of movement of lever arm which interacts directly with the switch. In reverse operation, the movement of the lever is in fact commanded by the action of the compression force of the first spring which is then compressed. A maximum force is exerted by this first spring. Said force, which his generally high, can result in very fast rotation of the lever and bring about a too sharp change of electric state that is liable to damage the electric contact. As the speed of change of electric state of the electric contact is greater than that which is recommended for such an electric cell, rapid deterioration of said cell is observed.

The solution described in the document EP1052664 enables this drawback to be remedied. Indeed, in reverse operation, switching from the second electric state to the first electric state only takes place by the action of a calibrated second spring. This change of state is therefore independent from the compression force applied by the first spring. The spring is calibrated so as to bring about the change of electric state of the switch or switches at a suitable speed that is not liable to damage the switch or switches. Disconnection then occurs between the operations proper of the operating means part of the push-button and of the control means part of the switch or switches.

The latter two solutions, respectively described in the documents EP 1052664 and U.S. Pat. No. 3,100,824, do however present the shortcoming of placing the electric contact of the switch under stresses when the detection device is at rest. This can result in premature wear of the switch. Furthermore, these solutions present relatively complex kinematic chains where translation movements are transformed into rotation movement and vice-versa. This mechanical complexity makes assembly and disassembly of the switches more difficult.

### SUMMARY OF THE INVENTION

The object of the invention is therefore to remedy the shortcomings of the state of the technique so as to propose an electric control switch with a push-button of simplified construction that is able to withstand high operating stresses and speeds.

The electric control switch with push-button according to the invention comprises disconnection means comprising means for moving said at least one electric contact from the first electric state to the second electric state and vice-versa at a speed the maximum value whereof is predetermined. The speed of movement of the electric contact or contacts from the first to the second electric state is independent from the speed of the first operating means when the speed of said first means is greater than a first predetermined maximum speed. The speed of movement of the electric contact or contacts from the second to the first electric state is independent from the speed of the first operating means when the speed of said first means is greater than a second predetermined maximum speed.

According to a development of the invention, the disconnection means comprise at least one flexible operating means supplying the internal operating force fixing a first predetermined maximum speed of movement.

Advantageously, a retractable stop frees the movement of the second operating means due to the action of the internal operating force when the first operating means moves due to the action of the external operating force.

According to a development of the invention, the disconnection means comprise an internal flexible operating means generating a holding force fixing the second predetermined maximum speed.

Advantageously, the holding force opposes the internal operating force and is of lower intensity.

According to a development of the invention, at least one flexible return means applies a return force on the operating push-button, the return force being designed to oppose the operating force.

Advantageously, the return force opposes the internal operating force and is of higher intensity.

Preferably, the second operating means move in translation in a parallel direction to that of movement of the first operating means.

Preferably, the first operating means comprise an external piston and the second operating means comprise an internal piston, said internal and external pistons comprising coaxial longitudinal axes.

### BRIEF DESCRIPTION OF THE DRAWINGS

Other advantages and features will become more clearly apparent from the following description of particular embodiments of the invention, given for non-restrictive example purposes only, and represented in the accompanying drawings in which:

FIGS. 1 to 3 represent schematic cross-sectional views of a switch with a push-button according to a known first embodiment, in different operating positions;

FIGS. 4 to 6 represent schematic cross-sectional views of a switch with a push-button according to a known second embodiment, in different operating positions;

FIG. 7 represents a schematic cross-sectional view of a switch with a push-button according to a first embodiment of the invention, in a rest position;

FIGS. 8 and 9 represent schematic cross-sectional views of a switch with a push-button according to FIG. 7, in an operating position;

FIGS. 10 and 11 represent detailed views of the operating push-button of the electric control switch according to the embodiments of the invention;

FIG. 12A represents an axial cross-sectional view of an electric control switch with push-button in a rest position according to an embodiment of the invention;

FIG. 12B represents a side view of an electric control switch according to FIG. 12A;

FIG. 13A represents an axial cross-sectional view of an electric control switch with push-button in a detection position according to an embodiment of the invention;

FIG. 13B represents a side view of an electric control switch according to FIG. 13A.

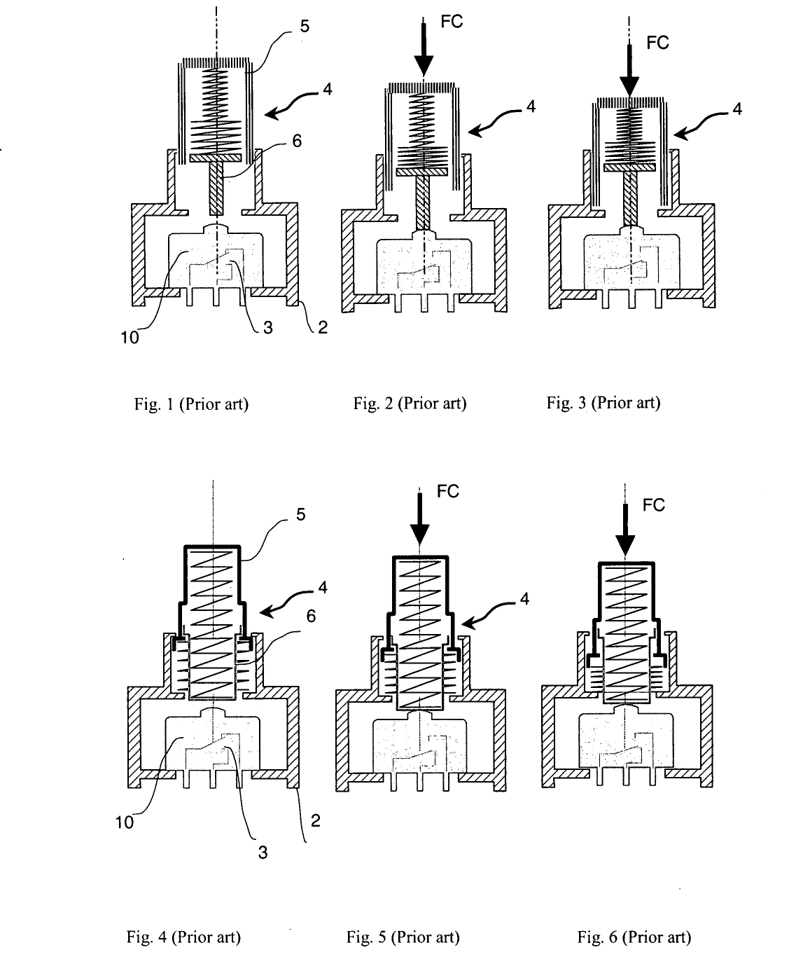

### DETAILED DESCRIPTION OF AN EMBODIMENT

In a first preferred embodiment of the invention as represented in FIG. 7, the electric control switch 1 comprises a case 2 containing at least one electric contact 3. The electric control switch 1 comprises an operating push-button 4 designed to be operated to change the electric state of said at least one electric contact 3.

According to this embodiment, the electric control switch 1 comprises an electric contact 3 having at least a first and a second electric state. The electric contact 3 is preferably integrated in an electric cell 10 such as a microswitch. The electric cell 10 can comprise an operating push-button 11, movement whereof between two extreme positions brings about a change of electric state of the electric contact 3.

According to this embodiment as represented in FIGS. 7 to 8, the electric contact 3 comprises two electric states. When the electric control switch is in a rest state, the first electric terminal A is connected to a third electric terminal C. When the electric control switch is in a detection state, the first electric terminal A is connected to a second electric terminal B.

The electric contact 3 is held in the first electric state called rest state by a holding force fm generated by a flexible operating means 9.

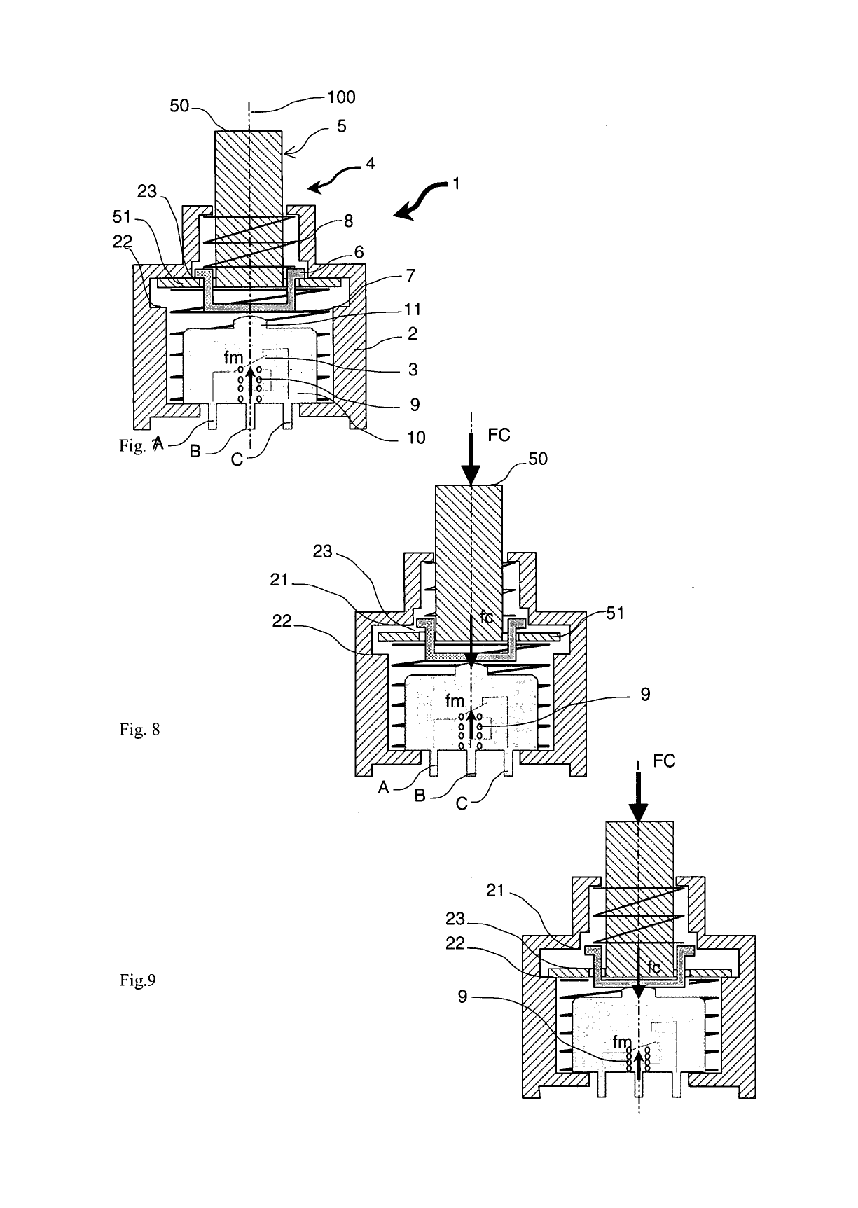

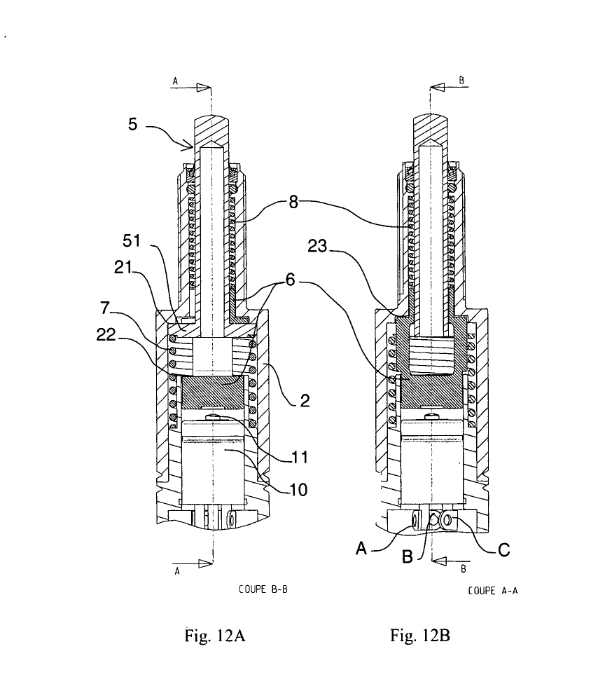

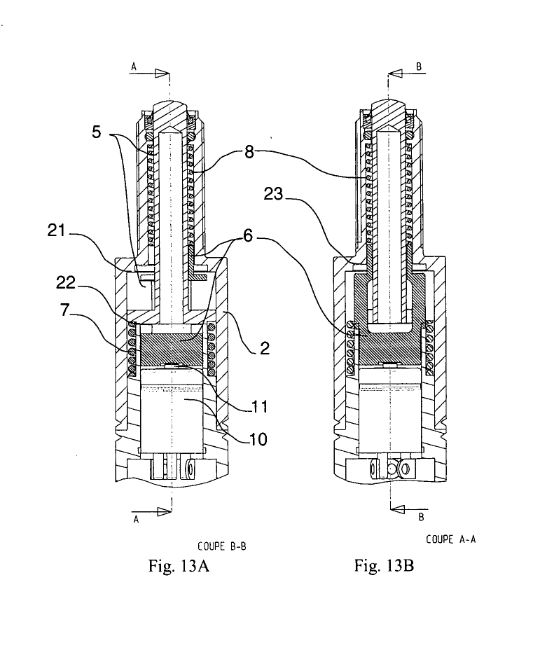

The operating push-button 4 can move under the action of an external operating force FC between the rest position and the detection position. The rest and detection positions are represented respectively in FIGS. 7 and 9. Said rest and detection positions are also represented in FIGS. 12A-B and 13A-B.

Said operating push-button 4 comprises a first operating means 5 on which the external operating force FC is designed to be applied. The first operating means 5 preferably comprise an external piston moving in translation along its longitudinal axis 100 inside the case 2. The movement travel of the external piston is limited by two positioning stops 21, 22. Preferably, the positioning stops 21, 22 form an integral part of the case 2.

According to a particular embodiment, the external piston comprises a cylindrical body having two ends. A first end comprises a first bearing face 50 on which the external operating force FC is applied. A second end of the external piston comprises a shoulder 51. An external face 52 of the shoulder 51 of the external piston comes into contact with the first stop 21 when the electric control switch 1 is in a rest position. A second stop 22 prevents movement of the external piston by means of the internal face 53 of the shoulder 51 when the electric control switch 1 is in its detection position.

In the rest position, the external piston is held against the first stop 21 by the action of at least one flexible return means 7. Said flexible means apply a return force FR on the external piston. The return force FR is designed to oppose the external operating force FC. The return force FR is preferably applied on the second end of the cylindrical body of the external piston. According to this example of embodiment, said at least one flexible return means 7 comprise a helical spring positioned between the bottom of the case and the internal face 53 of the shoulder 51 of the external piston.

The electric control switch 1 comprises disconnection means 6, 8, 9 between the first operating means 5 and the electric contact 3. The disconnection means 6, 8, 9 comprise means for moving the electric contact 3 from the first electric state to the second electric state and vice-versa at a speed having a predetermined maximum value. The speed of movement of the electric contact 3 is independent from the speed of the first operating means 5 when the speed of the first operating means 5 is higher than said predetermined maximum value. In other words, the disconnection means 6, 8, 9 enable a change of electric state of each electric contact 3 at a speed independent from the speed of the first operating means 5 of the operating push-button 4.

The operating push-button 4 comprises a second operating means 6 movement whereof causes the change of electric state of the electric contact 3. The second operating means 6 comprise an internal piston. Said piston internal comprises a longitudinal axis 100 coaxial with that of the external piston of the first operating means 5. Said second operating means 6 move in translation in a direction parallel to that of movement of the push-button 4.

According to one embodiment, the internal piston comprises a cylindrical body having two ends. The external surface of the cylindrical body has at least one flange 60. Said flange is preferably placed at a first end of said body. The internal piston comprises a bearing surface 61 designed to actuate the electric contact in the detection position. This bearing surface is preferably located at a second end of the piston. The internal piston is preferably hollow to be fitted sliding around the cylindrical body of the external piston.

According to a particular embodiment, the internal piston actuates the operating push-button 11 of the microswitch of the electric cell 10.

The disconnection means 6, 8, 9 comprise at least one flexible operating means 8 generating an internal operating force fc. This internal operating force fc fixes a first predetermined maximum value V1max of the speed of movement of the electric contact 3 from the first electric state to the second electric state.

This internal operating force fc is applied to the second operating means 6 to cause movement of the latter. The internal operating force fc is independent from the external operating force FC. The internal operating force fc is directly proportional to the stiffness of the flexible operating means 8.

The operating speed of the second operating means 6, in other words the speed of movement of the internal piston, will depend essentially on the internal operating force fc.

Moreover, the speed of movement of the second operating means 6 is independent from the speed of movement of the first operating means 5 when the speed of the first operating means 5 is greater than the first predetermined maximum value V1max.

According to this embodiment, said at least one flexible operating means 8 comprise a helical spring positioned between an internal surface of the case and the first end of the cylindrical body of the internal piston. The springs of the flexible operating means 8 and of the return means 7 are coaxial.

In the rest position of the electric control switch 1, the internal piston is held by the action of the internal operating force fc against a movable retractable first stop 23.

According to one embodiment of the invention, the movable retractable stop 23 forms an integral part of the external piston. The flange 30 of the internal piston is designed to come up against the stop formed by the external face 52 of the shoulder 51 of the external piston. The return force FR applied on the external piston is opposed to the internal operating force fc. Said return force then opposes movement of the piston internal indirectly. The return force FR is of greater intensity than the internal operating force fc.

Movement of the internal piston can only begin after the movable retractable stop 23 has been cleared. In other words, the internal piston cannot move when the external piston is positioned against the first stop 21, i.e. so long as the operating push-button 4 has not started its movement. Movement of the first operating means 5 due to the action of the external operating force FC releases movement of the second operating means 6 due to the action of the internal operating force fc.

The disconnection means 6, 8, 9 comprise an internal flexible operating means 9 generating a holding force fin on the electric contact or contacts 3. This holding force fin fixes a second predetermined maximum speed V2max of movement of the electric contact or contacts 3 from the second electric state to the first electric state.

Furthermore, the speed of movement of the electric contact 3 from the second electric state to the first electric state is independent from the speed of movement of the second operating means 6 when the speed of the second operating means 6 is greater than the second predetermined maximum value V2max.

The holding force fin opposes the internal operating force fc and is of lower intensity.

Operation of the electric control switch 1 is as follows.

Under the effect of the external operating force FC applied to the operating push-button 4, the first operating means 5 tend to move along their longitudinal axis 100. The electric control switch 1 leaves its rest state.

Movement of the first operating means 5 due to the effect of the external operating force FC releases movement of the second operating means 6. As soon as the movable retractable stop 23 is cleared, in other words as soon as the external piston starts to move, the internal piston in fact moves due to the action of the internal operating force fc.

Two operating modes are observable according to the speed of movement of the first operating means 5.

If the speed of movement of the first operating means 5 is greater than the first predetermined maximum speed V1max imposed by the internal operating force fc, the external and internal pistons move in the same direction but at different speeds. The external piston driven by the external operating force FC moves more quickly than the internal piston. Said internal piston then loses contact with the retractable stop 23. The speed of movement of the internal piston is then solely dependent on the operating force fc. Said operating force is calibrated in such a way that the operating speed and the force of impact of the internal piston on the electric contact 3 of the electric cell are not responsible for damage to said electric contact 3. According to this embodiment, the first operating means 5 can reach the second stop 22 before the internal piston has brought about the change of electric state of the electric contact 3. The first operating means 5 can then position itself on the second stop 22 before the electric control switch 1 is in its detection state.

If the speed of movement of the first operating means 5 is lower than or equal to the first predetermined maximum speed V1max imposed by the internal operating force fc, the external and internal pistons move in the same direction and at the same speed. The internal piston remains in contact with the movable retractable stop 23 during its movement. The speed of movement of the internal piston, substantially equal to that of the first operating means 5, is then imposed by the external operating force FC. According to this embodiment, in a first phase of the movement, the two internal and external pistons move together up to the moment when:
either the external piston comes up against its second stop 22 and is immobilized,
or the internal piston causes a change of electric state of the electric contact 3 and is immobilized.

The internal or external piston still in movement then finishes its travel and is immobilized in turn. The electric control switch 1 is then in its detection state.

In general manner, when the speed of movement of the first operating means 5 of the push-button 4 is greater than the first predetermined maximum speed V1max, the operating speed of the second operating means 6 only depends on the internal operating force fc; in other words the speed of movement of the electric contact or contacts 3 from the first electric state to the second electric state is totally independent from the speed of movement of the first operating means 5. In addition, the force of impact of the internal piston on the electric contact or contacts 3 is then also totally independent from the external operating force FC. In all cases, the maximum speed of the internal piston is imposed by the internal operating force fc.

Disconnection between the first operating means 5 and the electric contact or contacts essentially concerns the speed of movement of the external piston and the speed of change of electric state of the electric contact 3. Moreover, disconnection also concerns the intensity of the external operating force FC applied to the operating push-button 4 and the internal operating force fc tending to change the electric state of the electric contact 3.

When the external operating force FC is annulled, the electric control switch will leave its detection state and return to a rest state. The first operating means 5 then tend to move in the opposite direction due to the action of the return force FR.

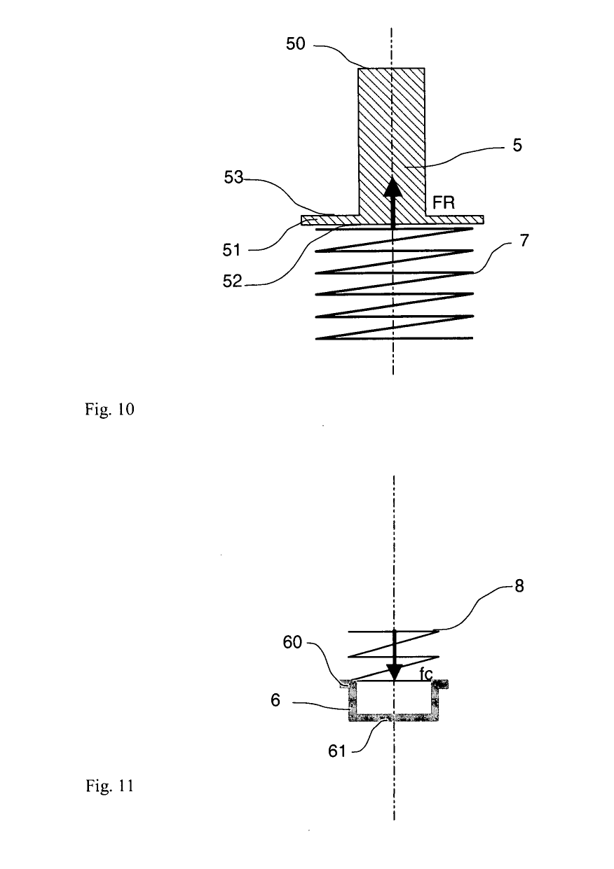

According to this embodiment, as represented in FIG. 10, the return force FR is applied to the internal face 53 of the shoulder 51 of the external piston of the first operating means 5.

During its movement, the external piston will drive the internal piston in translation, which piston has again come into contact with the movable retractable stop 23 of the external piston. As the return force FR is greater than the internal operating force fc, movement of the first operating means 5 causes that of the second operating means 6.

According to this embodiment, the internal piston then releases the pressure exerted on the electric contact 3 of the electric cell 10. Said electric contact resumes a rest position due to the action of the holding force fm of the internal flexible operating means 9. Said holding force fm fixes the second predetermined maximum speed V2max of movement of the electric contact 3 from the second electric state to the first electric state. The speed of movement of the electric contact 3 from the second electric state to the first electric state is independent from the speed of movement of the second operating means 6 when the speed of the internal piston of the second operating means 6 is greater than the second predetermined maximum value V2max.

As the return force FR is generally much greater than the holding force fm, the speed of change of electric state of the electric contact 3 is then fixed by the internal flexible operating means 9.

Thus, when the control switch returns to the rest position, disconnection is then observed between the speed of movement of the operating push-button 4 and the speed of change of electric state of the electric contact or contacts.

According to a first alternative embodiment, the electric cell which comprised three contacts A, B, C can be replaced by an electric cell with two contacts A, B. In this case, the first electric terminal A is disconnected from the second electric terminal B when the switch is in a rest state. In addition, the first electric terminal A is connected to the second electric terminal B when the electric control switch is in a detection state.

According to a second alternative embodiment, the electric control switch with a push-button comprises several electric cells. The electric control switch with a push-button can in fact be two-pole, three-pole or four-pole.

1. Electric control switch with a push-button comprising a case housing:
at least one electric contact having at least a first and a second electric state,
an operating push-button comprising:
a first operating means designed to move due to the action of the external operating force,
a second operating means moving due to the action of an internal operating force to move said at least one electric contact from a first electric state to a second electric state,
disconnection means between the first operating means and said at least one electric contact,
wherein the disconnection means comprise means for moving said at least one electric contact from the first electric state to the second electric state and vice-versa at a speed the maximum value whereof is predetermined,
the speed of movement of the electric contact or contacts from the first to the second electric state is independent from the speed of the first operating means when the speed of said first means is greater than a first predetermined maximum speed, and
the speed of movement of the electric contact or contacts from the second to the first electric state is independent from the speed of the first operating means when the speed of said first means is greater than a second predetermined maximum speed.

2. Control switch according to claim 1 wherein the disconnection means comprise at least one flexible operating means supplying the internal operating force fixing the first predetermined maximum speed.

3. Control switch according to claim 1 comprising a retractable stop releasing movement of the second operating means due to the action of the internal operating force when the first operating means move due to the action of the external operating force.

4. Control switch according to claim 1 wherein the disconnection means comprise a flexible internal operating means generating a holding force fixing the second speed predetermined maximum speed.

5. Control switch according to claim 4 wherein the holding force opposes the internal operating force and is of lower intensity.

6. Control switch according to claim 1 comprising at least one flexible return means applying a return force on the operating push-button, the return force being designed to oppose the operating force.

7. Control switch according to claim 6 wherein the return force opposes the internal operating force and is of higher intensity.

8. Control switch according to claim 1 wherein the second operating means move in translation in a parallel direction to that of the movement of the first operating means.

9. Control switch according to claim 8 wherein the first operating means comprise an external piston and the second operating means comprise an internal piston, said internal and external pistons comprising coaxial longitudinal axes.
